(19) United States
(12) Patent Application Publication
(10) Pub. No.: US 2007/0067203 A1
(43) Pub. Date: Mar. 22, 2007

(54) System for data collection from a point of sale

(76) Inventors: Sukenik Gil, Tel Aviv (IL); Yehiel Nadav, Rishon Lezion (IL)

Correspondence Address: Angenehm Law Firm, Ltd., P.O. Box 48755, Coon Rapids, MN, 56448-0755, US

(21) Appl. No.: 11/230,884

(22) Filed: Sep. 21, 2005

(51) Int. Cl. G06F 17/30

(52) U.S. Cl. 705/10

(57) ABSTRACT

Disclosed is a system for data collection from a point of sale, product display area, or point of service area, that includes a data receiving and processing center. The system is stand-alone and portable, and collects real-time data about the customers. Such data includes tracking the number of customers passing by a specific product, the average time that customers remain in front of the product, comparisons between the periods of time that customers remain in front of different products, and tracking the height and weight of potential customers in order to determine their demographic characteristics. The system utilizes different sensors, including infrared and proximity. A speech recognition application helps to recognize and analyze customers' reactions on certain products and converts speech to text. This speech recognition system is programmable to capture pre-defined key words rather than recording entire conversations. The system further allows on-line inventory tracking and market surveying.

### FIELD OF THE INVENTION

The present invention relates in general to systems and methods for collecting data about the reactions of potential customers to products; more particularly the invention relates to systems and methods of automatically monitoring the reactions of potential customers to products in real time by collecting statistical information about their actions and by analyzing segments of spoken phrases in the vicinity of the products' point of sale.

### BACKGROUND OF THE INVENTION

The moment when a potential customer comes in direct contact with a product in a store is the most significant moment which determines whether the customer will purchase the product or not. The reactions of customers to the product when they are standing in front of its point of sale are most important for the purpose of marketing and sales analysis. It is important to know whether the product attracted their attention, did they stop and look at it, did they pick it up and examined it more carefully and did they decide to take it or if they put it back. Analyzing these combinations of reaction of potential customers to a product at its point of sale is highly significant for improving marketing strategies.

All this data can disclose crucial information which may explain why certain products are accepted differently by customers even if the same marketing strategies are exercised on them. Yet this information is most difficult to attain. US Patent Application No. 2005086133 is an inventory tracking system and method. The patent application discloses a system and methods for sensing and analyzing inventory levels and consumer buying habits. It includes a sensor pad that can be installed on a display shelf. The controller of the sensor pad sends the data collected by it to a remotely located server that is managed by the inventory sensing service provider. This server converts the information in the reports into inventory data and stores this data in a database that customers of the inventory service can access remotely. International Patent Application No. 8907868 discloses a market research retail sales data collection system and method. Each in-store device which includes a store loop sensor assembly, a sensor interface, a store loop communications adapter and a central processing unit, continuously monitors, detects, interprets, processes and stores retail sales transactions data from its retail store for subsequent periodical transmission to the central site. Japanese Patent No. 2002032553 provides a customer information management system in which cameras photograph the persons who are sensed by corresponding sensors. A camera installed at a register photographs the customers who are purchasing the commodities at the register. A control part discriminates automatically customer attributes such as ages and sexes of customers by performing image processing according to the images of photographed customers.

None of the patents and patent applications of prior art integrates a speech recognition system for combining analysis of customers' verbal reactions to the product at the point of sale with all other information for the purpose of composing a comprehensive understanding of customer response to the product. In addition, automatic means for gathering customer behavior at the point of sale rely on receiving peripheral resources from the retail store selling the product, such as power sources and communication lines. In these cases their cooperation is needed in addition to their approval for operating a data collection device. Achieving this cooperation and resource allocation might prove to be a complex and cumbersome task. Even getting approval for installing a device which requires drilling into the store's shelves might demand an approval procedure which may delay the installation of such systems.

There is therefore a need for a solution which would allow automatic gathering of extensive information about the reactions of customers to a product at its point of sale. This solution need also operate as a fully independent unit which may simply be positioned at the designated point of sale without having to rely. on external resources for its operation.

### BRIEF DESCRIPTION OF THE DRAWINGS

These and further features and advantages of the invention will become more clearly understood in the light of the ensuing description of a preferred embodiment thereof, given by way of example, with reference to the accompanying drawings, wherein—

FIG. 1 is a block diagram illustrating possible components of the data collection unit according to a preferred embodiment of the present invention;

FIG. 2 is an illustration of the data collection unit as a single device housing all sensory units according to the first embodiment of the present invention

FIG. 3 is a schematic illustration of the operation of a single proximity sensor according to a preferred embodiment of the present invention;

FIG. 4 is a schematic illustration of the operation of two proximity sensors according to a preferred embodiment of the present invention;

FIG. 5 is a schematic illustration of the height measuring IR sensors positioned at different locations according to a preferred embodiment of the present invention;

FIG. 6 is a schematic illustration of the height measuring IR sensors positioned at a single location according to a preferred embodiment of the present invention;

FIGS. 7 and 8 are schematic illustrations of the curtain sensor according to a preferred embodiment of the present invention;

### DETAILED DESCRIPTION OF THE PREFERRED EMBODIMENTS

Disclosed is a system and a method for data collection from a point of sale, product display area, or point of service area, that includes a data receiving and processing center. The system is stand-alone and portable and collects real-time data about the customers. Such data includes tracking the number of customers passing by a specific product, the average time that customers remain in front of the product, comparisons between the periods of time that customers remain in front of different. products of the same type or similar products of different manufactures, and tracking the height and weight of potential customers in order to distinguish between children and adults. The system utilizes different sensors, including infrared and proximity. A speech recognition application helps to recognize and analyze customers' reactions on certain products and converts speech to text. This speech recognition system is programmable to capture pre-defined key words rather than recording entire conversations, in addition, it may identify the sex and age distribution of customers. Combined with an audio sound system, the speech recognition sensor may also be used to conduct automatic customer satisfaction surveys in real time. The system further provides the supplier with real time inventory tracking utilizing the standalone device as described herein.

The data collection unit disclosed in the present patent is especially designed for operating independently, as a standalone unit which does not require any resources from its environment such as power supply or communication infrastructure. It may fully operate by simply being placed on a given point of sale. This feature of the system allows it to be implemented according to the needs of its users, without relying on the cooperation of the store management. While there is no reason for the management of any store to object to its operation, having to ask for permission for using local resources may inhibit or delay the implementation of the system in some cases. In addition, the standalone configuration of the system allows it to be installed on temporary and provisional points of sale, or on points of sale which are located outside the confinements of a store, such as on the street or in passage ways of shopping centers. For this purpose the system is designed to operate on an independent power supply and to transfer data using wireless communication means.

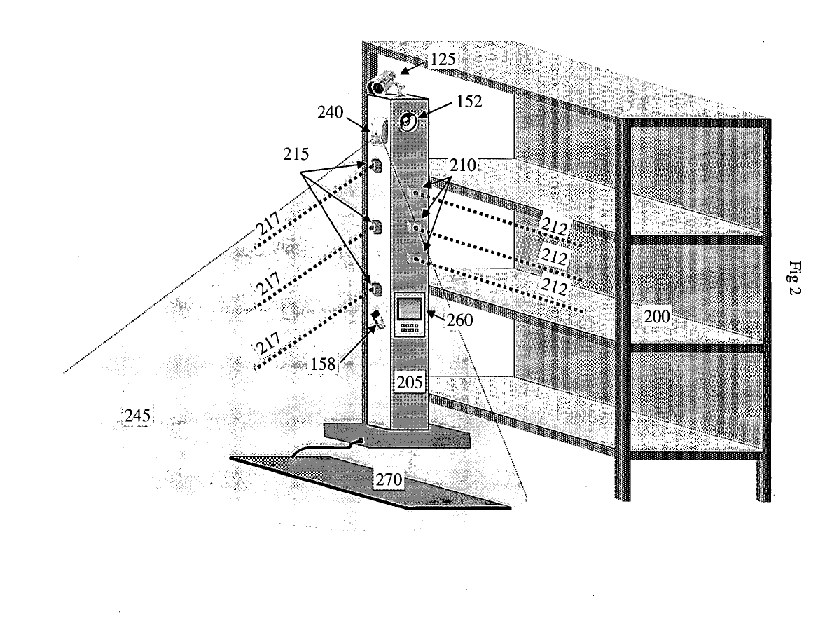

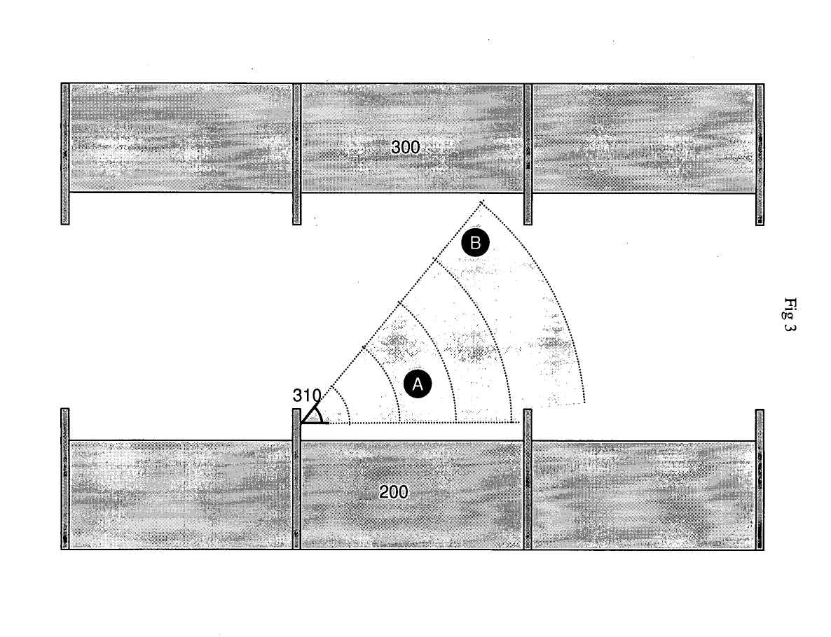

The first embodiment of the present invention, which is illustrated in FIG. 2, is comprised of a single device 205 which is located at the designated location, in front or along side of a point of sale 200. According to the second embodiment, the system is comprised of several sets of sensors positioned in strategic points around the designated location, but which are not housed in the same device. The different components of the second embodiment are illustrated in FIG. 3 to FIG. 8. The sets of sensors communicate through wired or through wireless communication with a central processing unit. Both embodiments operate under similar conditions and according to similar principles. The description that follows therefore refers to both embodiments.

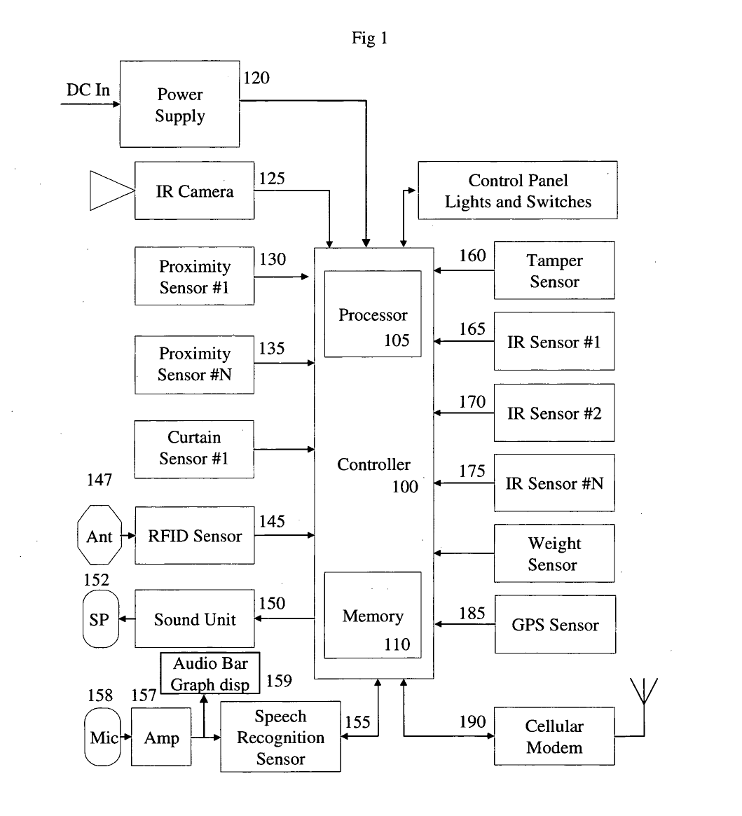

FIG. 1 is a block diagram illustrating possible components of the data collection device according to a preferred embodiment of the present invention. At the heart of the device is a controller 100 which includes a microprocessor unit 105 and a memory unit 110. The controller 100 collects the data from the different sensors, performs an initial analysis and stores the data in its memory unit 110. While all sensors are an integral part of the present invention, different embodiments may include different implementations of the configuration of the sensors according to the specific needs of the end users and the particular situations in which the device is used. These configurations may differ in their utilization of the sensors and therefore include different combinations of sensors.

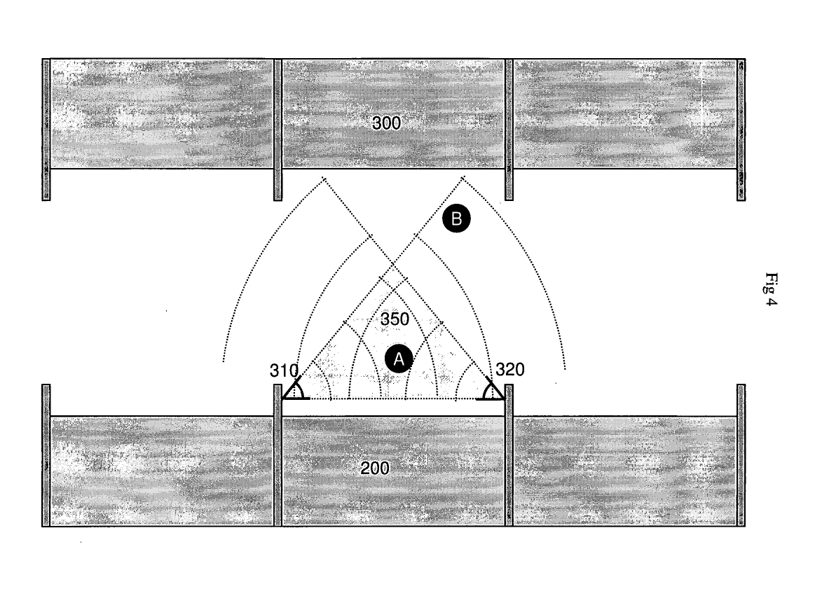

Proximity sensors 130-135 are any type of sensors which can detect that a person is approaching a particular point in space, such as volume sensors or heat detectors. In addition to recording that someone is in the area of the point of sale, the proximity sensors 130-135 may activate the device when a person is approaching if the device is programmed to switch into hibernation mode when it has nothing to record. FIG. 2 illustrates the operation of the proximity sensor 240 according to the first embodiment, whereas area 245 illustrates the zone of detection for proximity sensor 240. According to the second embodiment the system may need to rely on more then one proximity sensor, depending on the shape and structure of the point of sale stand. If, for instance, the stand may be approached from more then one side, an additional proximity sensor needs to be installed at each side. Additionally, as FIG. 3. and FIG. 4 illustrate, in some cases more then one proximity sensor may be needed in order to accurately determine the position of a person and avoid false positive registrations. In the examples illustrated in FIGS. 3 and 4 directional volume sensors are used to detect the presence of a person. In FIG. 3 a single proximity sensor 310 is positioned at the point of sale 200. In this case person A, who is approaching the point of sale 200, is detected by sensor 310. But person B is also detected by sensor 310 although he or she is approaching a different point of sale 300. To avoid such false positive registrations the operation of sensor 310 may be calibrated to detect the presence of a person only in a given distance. Alternatively, the solution illustrated in FIG. 4 may be implemented. A second sensor 320 is positioned on the other side of point of sale 200. In this case person B is only detected by sensor 310 and not by sensor 320, and the system registers the presence of a person only when both sensors detect his or her presence, i.e. only people who are in area 350. This method increases the reliability of the proximity sensors and ensures that only when point of sale 200 is approached the presence of a person is registered by the system.

Based on the data from the proximity sensors the system may record the amount of time in which people are present in the area of the point of sale. This may be valuable information for marketing personnel. If, for instance, the system measures very little traffic in the vicinity of the point of sale, while it is known that there was a significant amount of people in the store during this period, it is clear that the point of sale is in a remote position or that it is in an unfrequented part of the store. On the other hand, if the proximity sensors register a lot of traffic and yet only a small number of items of the given product are sold, then it is evident that the product is for some reason ignored by the majority of the customers.

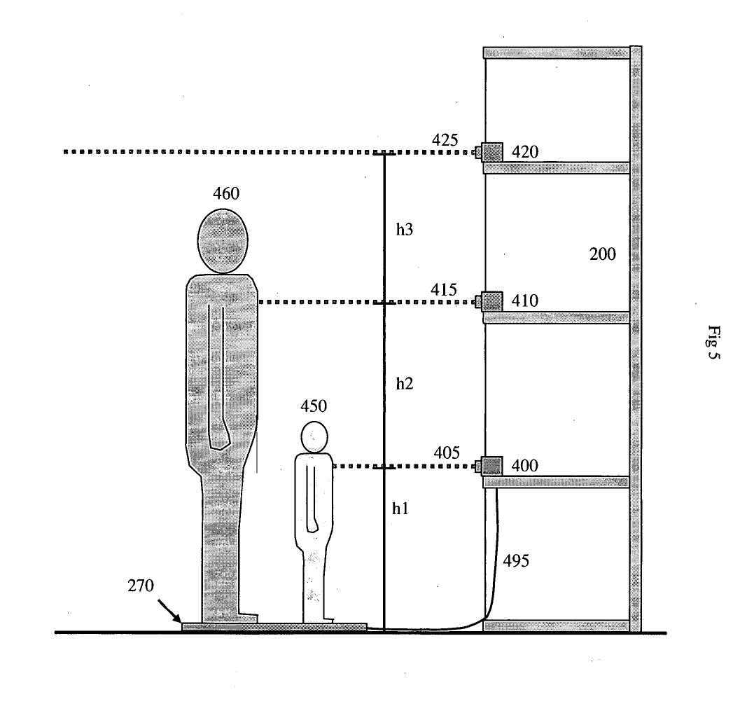

In addition to proximity sensors the device may include infrared (IR) sensors 165-175. The IR sensors 165-175 can not only sense when a person is approaching the point of sale, but also identify specific characteristics of the person, such as their height. The IR sensors are comprised of multiple IR beams set at different positions. Referring back to FIG. 2, according to the first embodiment, the IR sensors 215 are positioned at different heights on the face of device 205 which is directed towards approaching customers. A possible configuration of the IR sensors according to the second embodiment is illustrated in FIG. 5. In accordance with the second embodiment a set of IR sensors 400, 410, 420 is positioned at different heights on the point of sale stand 200, each sending a horizontal beam 405, 415, 425 in the direction of the customers 450, 460. Accordingly, in the first embodiment illustrated in FIG. 2 sensors 215 send horizontal beams 217 in the direction of approaching customers.

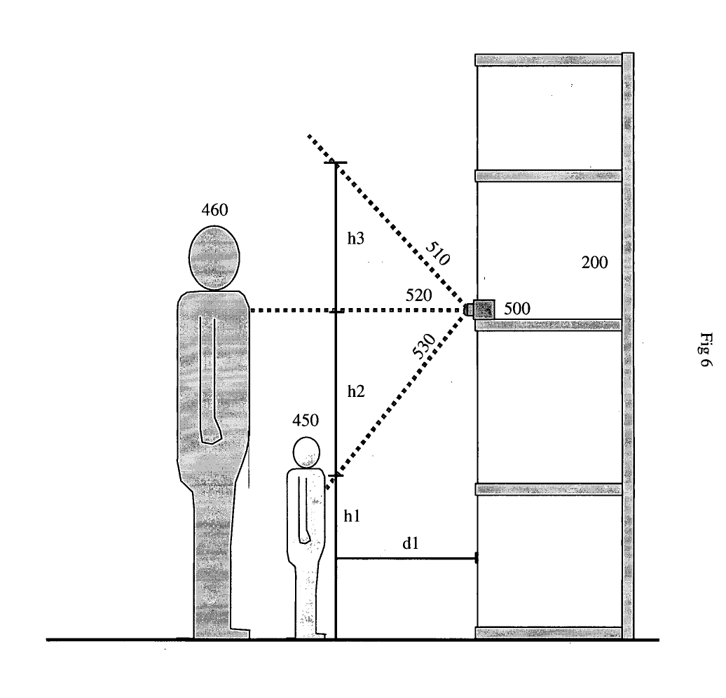

The manner of operation of the IR beams sensors is illustrated in FIG. 5. Since customer 450 is detected only by sensor 400 at height h1, while customer 460 is detected by sensors 400 and 410 at heights h1 and h2 but not by sensor 420 at height h3, it is easy to make crude conclusions about how tall the customers in front of the point of sale are. From a statistical standpoint, the height distinction can indicate whether a child or an adult is standing in front of the point of sale. Additional IR sensors may be used to achieve a more precise height distinction. Alternatively, provided that a proximity sensor is used, a single IR sensor may be used to distinguish between children and adults. In this case the beam is set at a given height; if the proximity sensor detects the presence of a person and the IR sensor does not, it is then possible to conclude that the person in front of the point of sale is shorter then the measured height. FIG. 6 illustrates an additional manner for performing the height measurement. The three IR sensors 500 in this example are positioned at the same height but send diagonal IR beams 510, 520, 530 in different angles. The diagonal beams are set to reach the relative heights (h1, h2, h3) at an arm-reach (d1) from the point of sale.

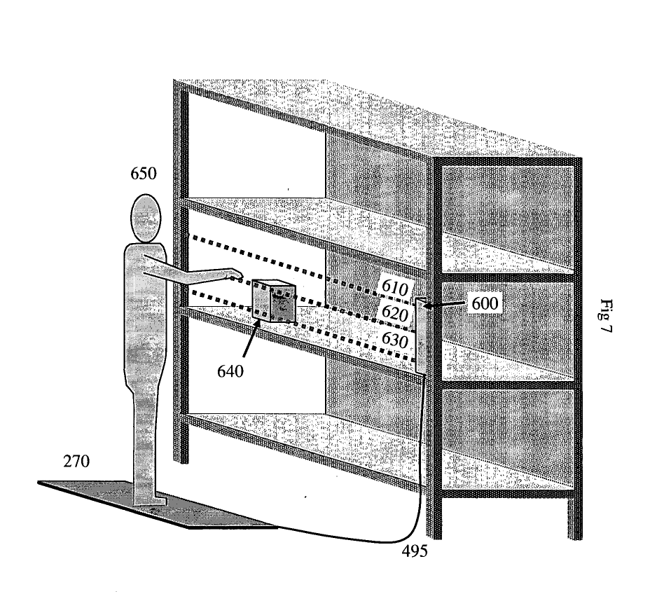

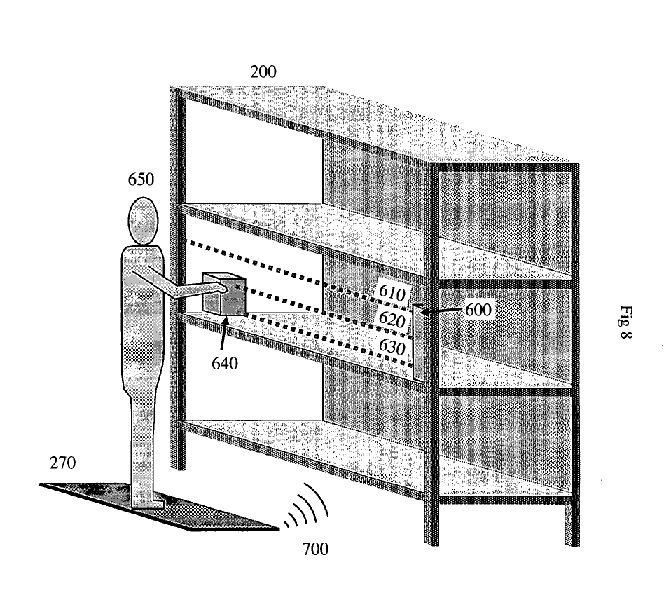

Additional information about the prospective buyers of the product may be gathered by a weighing sensor. Weighing mat 270 is illustrated in FIG. 2, FIG. 5, FIG. 7 and FIG. 8. It is positioned in front of the point of sale and may register the weight of the person standing on it. The Weighing mat sensor 270 may communicate with the system's controller 100 by wireless means 700 as illustrated in FIG. 8, or, as illustrated in FIG. 7, by wired means 495. Combined with data from the height IR sensors 215 or 400, 410 and 420, the bodily characteristics of the person standing in front of the point of sale may be statistically estimated. This information adds valuable data about the customers of the product.

Since it is very likely for potential customers to shop in groups, it is advantageous for the system to be able to estimate the number of people which are present in front of the point of sale at any point in time. For this purpose one of two methods may be utilized. The first uses an IR camera 125. IR cameras record the heat emanating from the body and the images they produced may be automatically analyzed for counting the number of people in a group. Provided that an IR camera is used, the proximity detector sensor described above become redundant since the IR camera image may be analyzed for extracting the information they produce—the number of people passing in front of the point of sale.

Additional IR sensors are the curtain sensors. According to the first embodiment of the present invention the curtain sensors 210 are positioned at different heights on device 205 and send horizontal beams 212 along the opening of point of sale 200. Similarly, FIG. 7 and FIG. 8 illustrate curtain sensor 600 according to the second embodiment and their manner of operation. The curtain sensor 600 sends multiple IR beams 610, 620 and 630 along the opening of point of sale 200. In order for customer 650 to reach product 640 which is located in point of sale 200, he or she has to cross the sensor's area of detection and this action is then registered by the system. The system can then track how many times customers reached for products in point of sale 200. In addition, the curtain sensor 600 can also tell if a customer 650 reached in for product 640 without withdrawing one from the point of sale or if a product was taken. As FIG. 7 illustrates, when the customer 650 takes product 640 out of point of sale 200, the size of the object measured by the curtain sensor 600 increases. This change in the size of the object detected by the beams of the curtain sensor 600 indicates that a product was taken off the shelf.

Being able to register the actions of the customers standing in front of the point of sale is particularly important for understanding customer reactions to a product. Once a potential customer is standing in front of the point of sale, one of several reactions might take place, whereas each of them may give a different explanation as for the decision making process which caused the customer to choose whether or not to buy the product. It is therefore important to know whether customers examine the product without reaching for it, whether they reached for it but did not pick up one, and whether they picked one up but put it back on the shelf, and if so, for how long they had it in hand before putting it back on the shelf or if they decided to take it with them. Tracking these patterns of actions is especially important when it is evident that customers do not choose to buy the product. Identifying, for instance, that a significant number of customers stopped and looked at the product but did not pick one up, or, on the other hand, picked one up but put it back on the shelf may indicate that in the two cases completely different reasons have caused them not to buy the product.

In order to more accurately monitor the reactions of customers to a product, the system may also incorporate a speech recognition sensor unit. The speech recognition sensor unit is designed to capture words and short phrases spoken in the vicinity of the point of sale, decipher the captured spoken language and search for particular words or word combinations. The speech recognition sensor unit does not record and store the conversations it captures, but counts how many times preprogrammed words and word combinations are identified. The users of the system may want to search for certain words and word combinations which may give an indication as for the customers' impression of the product, they may therefore want to program the sensor to search for words like “expansive”, “inexpensive”, “recommended”, “tasty”, “interesting”, and names of competing brands, and word combinations such as “I want this”, “that's nice”, “too sweet/salty/sour”, “it's better then . . . ”, “it's not as good as . . . ” and “I'd rather get . . . ”. The system may also record and decipher words which are said in relation to predetermined expressions such as the name of the brand or of competing brands. To better understand the different reactions of customers to the products, the system may also correlate the verbal reactions of the customers with other actions registered by the system. For instance, the system may identify that particular words or phrases are uttered by customers who return the product after taking it off the shelf.

Referring back to the block diagram of FIG. 1, the speech recognition sensor unit is comprised of a microphone 158, an amplifier 157, a speech recognition sensor 155 and an audio bar graph display 159. The microphone 158, which is also illustrated in FIG. 2, captures words which are spoken in the vicinity of the point of sale by bypassing customers. This data is then analyzed by the speech recognition sensor 155. The purpose of amplifier 157 is to increase the level of the input signal captured by microphone 158, and the audio bar graph display 159 gives a graphical indication as for the levels of signals amplified by amplifier 157. The main purpose of the audio bar graph display 159 is to assist during system installation and configuration to set the microphone volume to an optimal level.

In addition to analyzing words and phrases said by customers in the vicinity of the point of sale the speech recognition sensor unit may also be used to classify speakers according to their age and sex distribution. Analyzing the pitch of the voices, in addition to other characteristics, may help the system to more precisely determine the demographic characteristic of potential customers. The system may correlate data collected by the IR and weight sensors to increase the reliability of the demographic analysis of the customers.

Combining the information gathered by the speech recognition sensor unit with information from other sensors may give rise for better understanding the customers' reactions to the product. If, for instance, the system records that a significant amount of customers who stall in front of the point of sale and choose not to buy the product, also say the name of a competing brand, it is likely to conclude that something about the other brand causes these customers not to purchase the product. On the other hand, if the name of the competing brand is recorded as said by customers that choose to buy the product, it may be concluded that this product has some kind of advantage over its competition. Based on information collected by it, the system may learn what makes customers prefer one product over another. The system may also include a sound unit 150, which connects to speakers 152, illustrated in FIG. 1 and FIG. 2. The sound unit may sound sale promotion audio outputs, such as a tune which is associated with the product, or a short sales promoting text. The unit may be activated only when the system senses the presence of customers, or in response to an operation performed by the customers such as reaching for the product. Combined with the speech recognition sensor unit the system may offer customers the chance to participate in a short survey by posing questions to them and recording their responses using the speech recognition sensor unit or a touch screen. The system may then be used for gathering valuable information from potential customers in real time.

An additional sensor mechanism which can be integrated into the proposed system is a radio frequency identifier (RFID) sensor 145. Provided that RFID tags are attached to each product, the RFID sensor 145 can give an indication as for the number of products in the point of sale at any given moment. Although RFID sensors are becoming commonplace as an inventory tracking systems at the store level, it is especially beneficial to incorporate it into the system of an individual point of sale, since having to rely on the system of the store is cumbersome, demands the cooperation of the store management and may not give a clear and precise data in real time. The RFID sensor 145 may give clear indications for the rate in which products are taken from the point of sale over time; the end users of the system may access this information online using a designated website. Based on the information from the RFID sensor 145 the unit may send a warning to its operators when the amount of products in the point of sale drops beneath a predetermined threshold and is about to run out. This data is particularly important when the product in question is under intensive promotion efforts, since inventory management in such cases may have crucial consequences on the promotion campaign.

Synchronizing the data collected by a RFID sensor 145 at the point of sale with information from the system's other sensors may give an accurate indication as for the amount of products which were taken from the point of sale by customers. It may, for instance give an indication as for the type of customers which are more likely to purchase the product, such as their age and sex distribution. Depending on the type of information which the user wants to derive from the system, the RFID sensor 145 may be used instead of some of the other sensors of the system, such as the curtain sensor, or in addition to them.

A global positioning system (GPS) sensor 185 may be integrated into the system for two main purposes. The first is to automatically associate location data with the data gathered by the system. This data is especially beneficial when a large number of data collection units are installed on many points of sale, possibly in different geographic location around the world. As the information which is gathered by each data collection unit is sent to a central remote database, a location identification field may be automatically added by the data from the GPS sensor 185.

In addition, the GPS sensor 185 may also be used in case of theft. Since the data collection unit is a portable and standalone system, it may easily be removed unlawfully from its location. In such cases the GPS sensor 185 may aid the owners of the system to easily locate and restore it. Other sensors may also be used for preventing tampering with the system. Such tamper sensors 160 may include a motion detector sensor, a touch sensor and a contact sensor. The operators of the system, who are authorized to move the system and change its modes of operation, may be required to enter a password, a pin code or use any other means of identification and validation before they can operate the system. When the tampering sensors, such as the motion detectors which can identify when the unit is picked up and removed from its position, identify that the unit or the unit components are being touched or moved the system may conclude that it is an unauthorized operation. In such cases, the unit may send a warning signal to its operators or sound an alarm.

Similarly, the system may be protected from tampering and theft by touch detectors or by contact sensors. A touch detector identifies when the unit is being touched by a person according to the changes in the conductivity of the housing of the unit or of any of its components. A contact sensor is comprised of two parts which are magnetic or conductive: the first is attached to the base of the housing of the unit or of its components, and the second is place underneath the unit on the floor or on the shelf where it stands. When installed, the two parts of the sensor are positioned such that they are in very close proximity, if the sensor is magnetic, or in direct contact, if it is conductive. The sensor can then identify whenever the unit or any part of the unit's components are moved from their designated location. In such cases, the unit may send a warning signal to its operators or sound an alarm.

In addition to gathering information about its point of sale, the data collection unit may also gather information about neighboring points of sale for the purpose of comparison. For instant, the system may compare the amount of time customers spend in front of its point of sale to the time they spend in front of other points of sale. Combining information from its proximity sensors with data from the speech recognition sensor unit, the system may also distinguish between words and phrases uttered in its immediate proximity, and those said next to other points of sale in its surroundings. Analyzing the comparative information may help better understand customers' patterns of behavior.

Each unit may include LED lights, graphic display 260 which give indications as for the operation of the unit, and switches for configuring it locally. The display may provide information about the status of each of the system's components, the remaining time left in its power resource and the status of the communication means. It may also give indications as for its programmed parameters, such as its data transference rate and the data's destination. Display 260 may be configured to display information only during the installation and configuration stages. Once the system is in full operation this display 260 may be turned off to avoid attracting the attention of customers. Alternatively, during the normal operation of the unit display 260 may display product promotion materials or pose questions to customers during the customer satisfaction surveys. For this purpose display 260 may be a touch screen.

As mentioned above, all data from the sensors is transferred via wired or wireless means to the local controller 100. Controller 100 gathers the data from the sensors, adds a time and location stamp to it, and performs initial analysis on it to optimize its memory and communication resources. Controller 100 may also execute preliminary statistical calculations on the data gathered by it. The operation of controller 100 is fully programmable both at the installation and configuration stages and in real time during the system's operation from a remote location through the communication means 190. Controller 100 manages the operation of the sensors and controls their activation and data transference rates; it may also periodically perform operational tests to validate that all sensors are working properly. At predetermined times controller 100 initiates communication with the data destination server and sends all relevant data to it using wireless communication means such as a cellular modem 190. In cases of unexpected or critical situations, such as when the data collection unit is tampered with or if the product is about to run out, the controller 100 may initiate sending an emergency message to a designated recipient.

The data is sent and gathered in a designated remote database. According to one embodiment the system may be operated by a service provider which offers the system's utilities to the end users. In such cases the raw data collected by each controller 100 may be sent to the central server of the service provider and processed there. Alternatively, the system may be operated by the end user and the data is then sent to the databases of the user. While the former embodiment facilitates the data management procedure for the end user, the latter embodiment allows the end users to receive real time data directly from each data collection unit.

While the above description contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A system for data collection at a service area, said system comprised of:
at least one portable standalone data collection device including at least one measuring unit enabling to detect and record real-time customer activities and characteristics including verbal and vocal responses relating to merchandise within the service area, analyzing module for filtering measured data and transmission module for conveying filtered data through wireless data network to at least one terminal.

2. The system of claim 1 wherein the customer activities include one of the following: customer approaching certain point within the area, customer stalling in front of a certain point within the area, customer reaching for a product, customer taking merchandise, customer returning merchandise to the shelf, customer facial expressions, customer pronouncing specific phrases regarding the merchandise.

3. The system of claim 1 wherein the customer characteristics includes one of the following: height, weight, age, sex, number of people in a group of customers.

4. The system of claim 1 wherein the measuring unit includes at least one of the following: infrared sensor, proximity sensor, speech recognition, curtain sensor, RFID sensor, GPS sensor, weight sensor, tamper sensor, touch sensor, infrared camera.

5. The system of claim 1 wherein the vocal response include detection of pre-defined vocal sounds or voice recognition of predefined words for statistic analysis of customer reaction.

6. The system of claim 1 further including remote analyzing unit which receives filtered data and perform statistic analysis.

7. The system of claim 6 wherein the statistic analysis enable identifying trends in customer behaviors, and rating of products sales within the service area.

8. The system of claim 1 further including a speaker unit for providing audio output which is associated to relevant product and customer activity.

9. The system of claim 8 further including survey module enabling prompting the user with short survey and recording user responses.

10. The system of claim 1 further including a GPS unit for correlating the collected data with the geographic location of the service area.

11. The system of claim 1 further including a touch sensor for ensuring authorized handling of the portable device.

12. The system of claim 1 further including real time inventory tracking module

13. The system of claim 1 further including a movement detection sensor for ensuring authorized handling of the portable device.

14. The system of claim 1 further comprising a central processing unit for gathering and analyzing all data received from the collection devices, wherein the devices are located in different geographical locations.

15. The system of claim 1 wherein the collection device further include a touch screen associated with survey module enabling to the user to respond to the survey question using the touch screen.
A method for collecting data representing user behavior, comprising the step of:
detecting and measuring user activities and characteristics including vocal sounds, wherein said activities relates to user response to products within the service area.
filtering collected data and
transmitting filtered data through wireless data network to at least one terminal.
